(19) United States
(12) Patent Application Publication
(10) Pub. No.: US 2006/0277478 A1
(43) Pub. Date: Dec. 7, 2006

(54) Temporary title and menu bar

(75) Inventors: Seana Seraji, Seattle, WA (US); Aaron Filner, Seattle, WA (US); Jay F. McLain, Woodinville, WA (US); Randal J. Ramig, Seattle, WA (US); Vinoo Cherian, Kirkland, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/144,138

(22) Filed: Jun. 2, 2005

(51) Int. Cl. G06F 9/00

(52) U.S. Cl. 715/760

(57) ABSTRACT

A determination is made as to when to display and hide obstructive user interface elements. Obstructive user interface elements are removed from the display when not needed by the user and displayed when needed by the user. When the obstructive interface elements are removed from the display, the user has more viewable area that is not obstructed. For example, in some browser applications, when the title bar, address bar and menu bar are removed, the user is provided with a view that shows much more of the web page. When the obstructive user interface elements are needed, they are temporarily displayed on the device. Once the task has been completed, the obstructive user elements are then hidden again automatically, which allows the user to continue viewing in full screen mode.

### BACKGROUND

Mobile devices, such as mobile phones, are becoming much more popular than just a few years ago. Many people are no longer using their land lines are relying solely on their mobile phone. This is evidenced by the fact that mobile phone usage just recently surpassed home phone usage. Additionally, mobile phones, and other mobile devices, are being used for much more than just making and receiving telephone calls. Many mobile phones may now be used to make and receive calls, browse the Internet, send and receive email, watch videos, as well as a variety of other tasks. These “smartphones” are becoming powerful computing devices. These devices, however, typically have a small screen on which to display content. With such limited screen space available, it is difficult to display as much information as desired. For instance, browsing the Internet can be awkward and difficult, as most sites are developed for high resolution color monitors typically associated with desktop computing devices. Accessing these pages on a mobile device typically requires the user to scroll the web page both horizontally and vertically on their device in order to view the entire page. As a result of the limited screen space, application developers are attempting to efficiently use the available screen space. For example, web browsers have been developed for mobile devices that attempt to reformat website content such that it fits within the limited screen space now available on a mobile device.

### SUMMARY

Embodiments of the present invention relate to hiding and displaying obstructive user interface elements based on a determination of when the obstructive user interface elements are needed by a user.

According to one aspect of the invention, obstructive user interface elements are removed when they are predicted to not be needed by the user. Removing the obstructive user interface elements provides the user with more viewable area. For example, in some browser applications, the title bar, address bar and menu bar obstructive user interface elements may be removed in order to maximize the view of the content presented to the user. When the obstructive user interface elements are removed, the user may see much more of the web page as compared to when the user obstructive interface elements are displayed.

According to another aspect of the invention, the obstructive user interface elements are temporarily displayed when they are predicted to be needed. The prediction may be based on a user action and/or an event associated with an application. For example, when the user attempts to interact with a menu item associated with the web page, the obstructive user interface elements are temporarily shown to the user. Once the task has been completed, the obstructive user interface elements are then hidden again automatically, which allows the user to continue viewing in full screen mode.

### BRIEF DESCRIPTION OF THE DRAWINGS

FIG. 1 illustrates an exemplary computing device that may be used in exemplary embodiments of the present invention;

FIG. 2 shows exemplary windows that include a window displaying obstructive user interface elements and a window not displaying the obstructive user interface elements;

FIG. 3 illustrates a process flow for determining when to display and when to hide the obstructive user interface elements;

FIG. 4 shows a diagram determining when to show the obstructive user interface elements; and

FIG. 5 shows a diagram determining when to hide the obstructive user interface elements, in accordance with aspects of the invention.

### DETAILED DESCRIPTION OF THE PREFERRED EMBODIMENT

Generally, embodiments of the present invention are related to hiding and displaying obstructive user interface elements based on a determination of when the obstructive user interface elements are needed by a user. The obstructive user interface elements are removed from the display when not needed by the user and displayed when needed by the user. When the obstructive user interface elements are removed from the display, the user is able to see more content. For example, in some browser applications, when the title bar, address bar and menu bar are removed, the user is provided with a view that shows much more of the web page. When the obstructive user interface elements are needed, they are temporarily displayed on the device. Once the task has been completed, the obstructive user interface elements are then hidden again automatically allowing the user to continue viewing in full screen mode.

Illustrative Displays with and without User Interface Elements

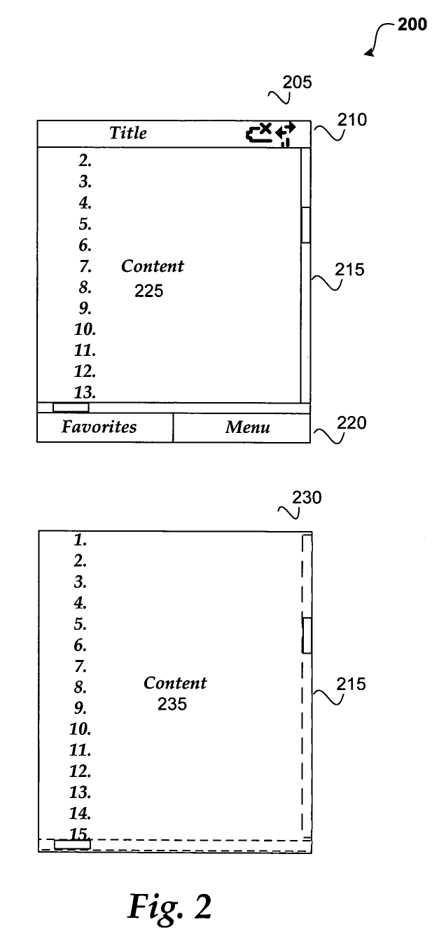

FIG. 2 shows exemplary windows that include a window displaying obstructive user interface elements and a window not displaying user interface elements, in accordance with aspects of the invention. In order to maximize view within the window, the obstructive user interface elements are removed from the users view, thus providing them with more screen real estate that is available for viewing. The obstructive user interface elements are shown to the user when needed.

According to one embodiment of the invention, the obstructive user interface elements are removed from windows and/or screens having a limited display area as compared to full size windows. The windows illustrated (205 and 230) in FIG. 2 have a limited display area as compared to full size windows that may be displayed on a desktop computer. Full size displays associated with desktop computers typically range from 12 inches to 23 inches and may be set to many different resolutions, including common resolutions, such as: 1024×768, 1152×864, 1280×1024, 1600×1200, 1920×1080, 1920×1200, 1920×1440, 2048×1536 and the like. Most portable devices, such as mobile phones, on the other hand, have limited screen sizes (typically 2-4 inches) and have resolutions such as: 640×480, 240×320, 320×320, 176×220, 240×260 and 160×160. Both full size displays and portable devices, however, may set their resolutions to any available resolution on the device. A small screen may be defined as any screen or window that is smaller than twelve inches and has a resolution less than or equal to 640×480. A mobile screen is any screen and/or window that is displayed on a mobile device.

As illustrated, window 205 is shown with the obstructive user interface elements displayed. In this particular example, the window includes a title bar (210) obstructive user interface element and a menu bar (220) obstructive user interface element. Other obstructive user interface elements may be displayed depending on the application and/or device being used. For example, the obstructive user interface element could be only a single menu that takes up a portion of the screen. Generally, anything that obstructs a portion of the screen space may be considered an obstructive user interface element. According to one embodiment, for example scroll bars 215 may be considered an obstructive user interface element.

Window 230 illustrates a window not displaying some of the obstructive user interface elements. As can be seen by comparing the content (235) within window 230 to the view of the content (225) within window 205, much more of the content is visible within window 230. In the present example, when the obstructive user interface elements are not displayed, the numbers 1, 14 and 15 may be seen in window 230. Removing the obstructive user interface elements can provide the user with a much larger viewing area for the content as compared to when they are shown. According to one embodiment, some obstructive user interface elements may always be shown. In the present example, obstructive user interface elements 215 are displayed. According to another embodiment, obstructive user interface elements 215 are not displayed. An authorized user may set conditions upon which obstructive user interface elements are shown. For example, the settings could indicate whether to display or not display the scroll bars. If the scroll bars are not displayed, then some other indication could be provided to the user showing them that content extends beyond their screen. Alternatively, no indication could be provided to the user until they attempt to scroll or manipulate the position of the content. According to another embodiment, the Address bar is an obstructive user interface element that can be selectively displayed or hidden.

The obstructive user interface elements are hidden and displayed based upon a prediction of when the elements are needed and when they are not needed.

Illustrative Process and Conditions for Displaying and Hiding Obstructive User Interface Elements

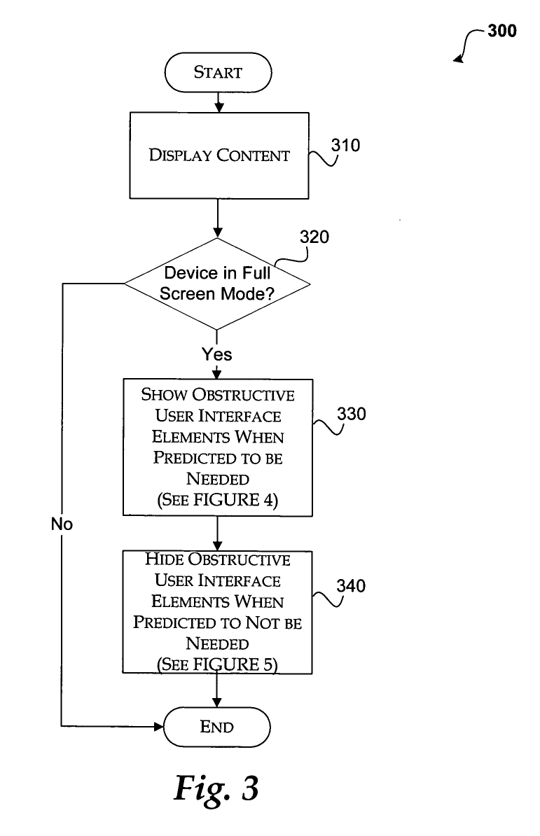

FIG. 3 illustrates a process flow for determining when to display and when to hide the obstructive user interface elements, in accordance with aspects of the invention.

After a start block, the process flows to block 310 where the content is displayed on the screen. According to one embodiment, the obstructive user interface elements are displayed when the content is initially displayed on the device. This provides the user with a view showing them that there are user interface elements associated with the content. According to one embodiment, the screen is not resized when the obstructive user interface elements are displayed. Instead, the obstructive user interface elements are displayed on top of any content that may already be located where the obstructive user interface elements are to be placed.

Moving to decision block 320, a determination is made as to whether the device is in full screen mode. When the device is in full screen mode, the user desires to maximize the amount of time that they spend in full screen mode while minimizing the number of times they are in a normal view mode where obstructive user interface elements would be displayed.

When the device is not in full screen mode, the process moves to an end block. When the device is in full screen mode, the process moves to block 330.

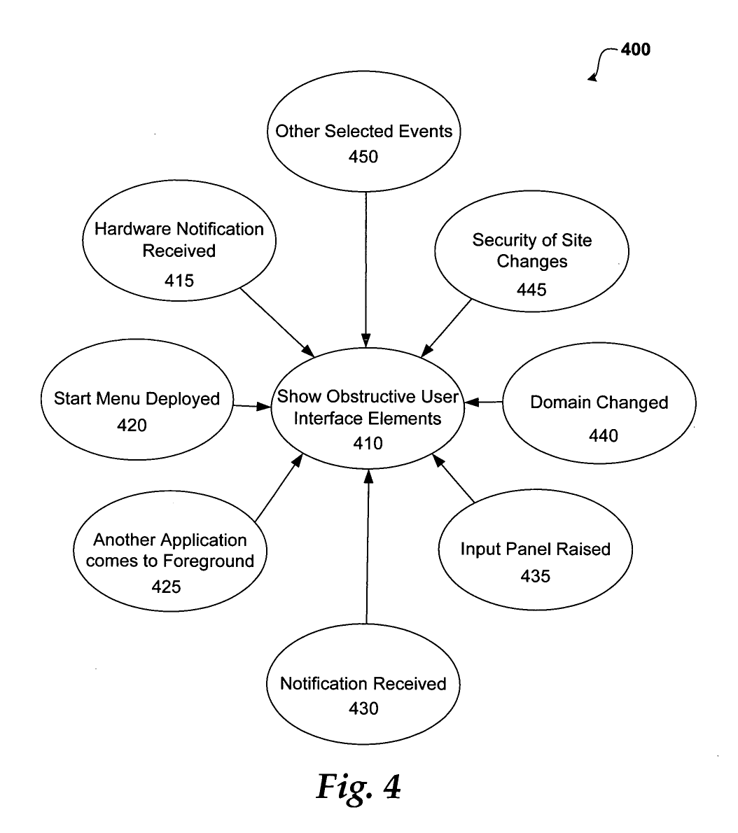

At block 330, an attempt is made to only display the obstructive user interface elements when they are needed by the user. Generally, the obstructive user interface elements are shown when a predefined condition occurs (See FIG. 4 and related discussion).

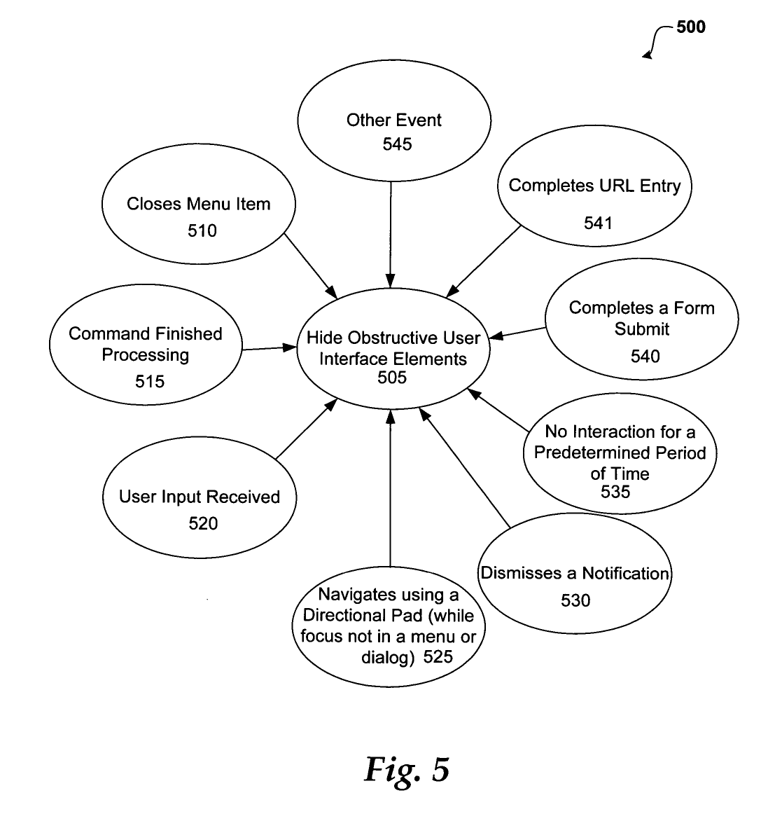

Flowing to block 340, an attempt is made to hide the obstructive user interface elements when they are not needed by the user. Generally, the obstructive user interface elements are hidden after the task requiring the obstructive user interface elements has completed (See FIG. 5 and related discussion).

The process then moves to an end block and returns to processing other actions.

FIG. 4 shows a diagram determining when to show the obstructive user interface elements, in accordance with aspects of the invention. The obstructive user interface elements are presented to the user upon the occurrence of various predefined conditions. Ideally, the obstructive user interface elements are shown (410) only when the user is going to access one of the menu items within one of the obstructive user interface elements, or when the user is presented with information concerning the application, or other applications on the mobile computing device.

Condition 415 indicates that the obstructive user interface elements are shown when a hardware notification is received. The notification may be a hardware notification as well as a software notification. A notification could be triggered upon many different conditions. For example, the user could press a hardware key on their device that is associated with a menu for the application. For example, a user could select a hardware key that is associated with opening a file box dialog. A user could also press a key that is associated with a soft key menu item (See element 220 in FIG. 2).

Condition 420 indicates that the obstructive user interface elements are shown when a start menu is deployed.

Condition 425 shows that when another application is brought to the foreground of the display, the obstructive user interface elements are shown.

Condition 430 indicates that the obstructive user interface elements are shown when a notification is received. For example, the obstructive user interface elements may be shown when the user receives an SMS notification, an email notification, an IM notification, an incoming telephone call notification, and the like.

Condition 435 shows the obstructive user interface elements when the input panel is raised. An input panel is a user interface element that allows the user to enter information more easily into their application as compared to using the hardware keys on their device. For example, an input panel may be configured as a QWERTY keyboard allowing the user to select letters from the input panel in the same way as they would type them.

Condition 440 displays the obstructive user interface elements when the domain of the site the user is viewing changes. For example, when the user is web browsing and changes the domain, the obstructive user interface elements may be temporarily shown to the user showing them the domain change. Showing the user the domain change helps provide the user with information such they are not inadvertently directed to a malicious site.

Similarly, condition 445 displays the obstructive user interface elements when the security of the site changes. For example, the user may be at a secure site and then be directed to a non-secure site. Without the notification, the user may inadvertently enter information that may be compromised.

According to one embodiment, the obstructive user interface elements may also be shown upon the occurrence of other selected events (450). These events may be configured by the user, a system administrator, the device manufacturer, or some other authorized user. For example, the obstructive user interface elements could be shown when the user taps within a certain location of the screen, when they receive a message from a certain individual, when a calendar event occurs, and the like.

FIG. 5 shows a diagram determining when to hide the obstructive user interface elements on a display, in accordance with aspects of the invention. The obstructive user interface elements are hidden from the user upon the occurrence of various predefined conditions. Ideally, the obstructive user interface elements are hidden from the user (410) when the task involving the obstructive user interface elements has completed.

Condition 510 hides the obstructive user interface elements when the user closes an open menu. For example, the user closes an open soft key menu item.

Condition 515 hides the obstructive user interface elements when the command that caused the obstructive user interface elements to be displayed has finished processing. For example, the domain changed and the page has finished loading. Another example is when the user selects a menu item that requires processing a command and the command finished processing. According to one embodiment, the obstructive user interface elements may be removed before the command has finished processing.

Condition 520 hides the obstructive user interface elements upon the occurrence of a user input being received. Many different types of user inputs could dismiss the obstructive user interface elements. For example, the user could tap anywhere in the content, the user could tap in a predefined area, the user could select a hardware key on their device that instructs the device to hide the obstructive user interface elements.

Condition 525 hides the obstructive user interface elements when the user navigates with the directional pad while the focus is not in a menu or dialog.

Condition 530 hides the obstructive user interface elements when the user dismisses a notification. For example, a notification may be shown to the user when a message is received. When the user taps on the selection within the notification dismissing it, the obstructive user interface elements are hidden.

Condition 535 hides the obstructive user interface elements when the user does not interact with the device for a predetermined period of time. According to one embodiment, the obstructive user interface elements are hidden when the user does not interact with the device for more than 10 seconds. Other time periods may be chosen.

Condition 540 hides the obstructive user interface elements when the user completes a form submit.

Condition 541 hides the obstructive user interface elements when the user completes entering a URL.

Condition 545 hides the obstructive user interface elements upon the occurrence of some other event. These events may be configured by the user, a system administrator, the device manufacturer, or some other authorized user. For example, the obstructive user interface elements could be hidden when the user taps within a certain location of the screen, when certain content is displayed, and the like.

Illustrative Operating Environment

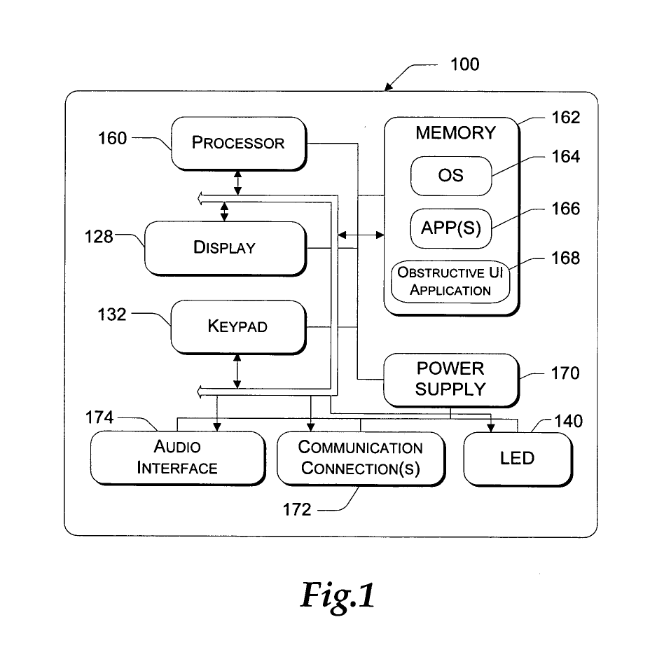

FIG. 1 illustrates a mobile computing device that may be used in one exemplary embodiment of the present invention. Mobile computing device 100 includes processor 160, memory 162, display 128, and keypad 132. Memory 162 generally includes both volatile memory (e.g., RAM) and non-volatile memory (e.g., ROM, Flash Memory, or the like). Mobile computing device 100 includes operating system 164, such as the Windows Mobile 2003 operating system or Windows CE from Microsoft Corporation, or another operating system, which is resident in memory 162 and executes on processor 160. Mobile computing device 100 may be configured in many different ways. For example, mobile computing device 100 could be a mobile phone, a PDA, a mobile computer, and the like. Keypad 132 may be a push button numeric dialing pad (such as on a typical telephone), a multi-key keyboard (such as a conventional keyboard). Display 128 may be a liquid crystal display, or any other type of display commonly used in mobile computing devices. Display 128 may be touch-sensitive, and would then also act as an input device.

One or more application programs 166 are loaded into memory 162 and run on the operating system 164. Obstructive UI application 168 is configured to temporarily display obstructive user interface elements associated with an application in response to the user's action. The application may reside in the hardware or software of the device. Mobile computing device 100 also includes non-volatile storage 168 within memory 162. Non-volatile storage 168 may be used to store persistent information which should not be lost if mobile computing device 100 is powered down.

Mobile computing device 100 includes power supply 170, which may be implemented as one or more batteries. Power supply 170 might further include an external power source, such as an AC adapter or a powered docking cradle that supplements or recharges the batteries.

Mobile computing device 100 is shown with two types of optional external notification mechanisms: LED 140 and audio interface 174. These devices may be directly coupled to power supply 170 so that when activated, they remain on for a duration dictated by the notification mechanism even though processor 160 and other components might shut down to conserve battery power. Audio interface 174 is used to provide audible signals to and receive audible signals from the user. For example, audio interface 174 may be coupled to a speaker for providing audible output and to a microphone for receiving audible input, such as to facilitate a telephone conversation.

Mobile computing device 100 also includes communications connection(s), such as a wireless interface layer, that performs the function of transmitting and receiving communications. Communications connection 172 facilitates wireless connectivity between the mobile computing device 100 and the outside world. The communication connection may be configured to connect to any type of wireless network. According to one embodiment, transmissions to and from communications connection 172 are conducted under control of the operating system 164.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computer-implemented method for managing the display of obstructive user interface elements on a device, comprising:
displaying content on a small screen;
determining when to show and hide an obstructive user interface element on the small screen;
showing the obstructive user interface element when determined, wherein showing the obstructive user interface element results in a portion of the content being hidden from view; and
hiding the obstructive user interface when determined.

2. The method of claim 1, wherein determining when to show and hide the obstructive user interface element on the small screen, comprises predicting when a user will need to use the obstructive user interface element.

3. The method of claim 2, wherein determining when to show the obstructive user interface element comprises: determining when at least one of the following condition occurs: a hardware notification is received, a start menu is deployed, another application comes to the foreground of the small screen, a notification is received, an input panel is raised, a domain changes, and a security level associated with a site changes.

4. The method of claim 2, wherein determining when to hide the obstructive user interface element comprises: determining when the event that caused the obstructive user interface element has completed.

5. The method of claim 2, wherein determining when to hide the obstructive user interface element comprises: determining when at least one of the following condition occurs: a menu item is closed, a command finishes processing, a user input is received, a user navigates using a directional pad, a notification is dismissed, a period of time elapses with no interaction, and a form submit is completed.

6. The method of claim 2, further comprising determining when the device is in a full screen mode.

7. The method of claim 2, wherein the obstructive user interface element is at least one of a title bar associated with a browser; an address bar; and a menu bar.

8. A computer-readable medium having computer-executable instructions for managing the display of obstructive user interface elements on a device having a small screen, comprising:
displaying content on the small screen;
determining when to show an obstructive user interface element over a portion of the content;
showing the obstructive user interface element when determined; and
hiding the obstructive user interface upon the occurrence of an event.

9. The computer-readable medium of claim 8, wherein determining when to show the obstructive user interface element, comprises: predicting a use of the obstructive user interface element.

10. The computer-readable medium of claim 9, wherein predicting the use of the obstructive user interface element, comprises: determining when at least one of the following condition occurs: a hardware notification is received, a start menu is deployed, another application is displayed on the foreground of the small screen, a notification is received, an input panel is raised, a domain changes, and a security level associated with a site changes.

11. The computer-readable medium of claim 8, wherein hiding the obstructive user interface upon the occurrence of the event, comprises: determining when the event that caused the obstructive user interface element has completed.

12. The computer-readable medium of claim 8, wherein hiding the obstructive user interface upon the occurrence of the event, comprises: determining when at least one of the following condition occurs: a menu item is closed, a command finishes processing, a user input received, a user navigates using a directional pad, a notification is dismissed, a period of time elapses with no interaction, and a form submit is completed.

13. The computer-readable medium of claim 9, further comprising setting the device to a full screen mode.

14. The computer-readable medium of claim 9, wherein the obstructive user interface element is a title bar associated with a browser.

15. A mobile device, comprising:
a processor and a computer-readable medium;
an operating environment stored on the computer-readable medium and executing on the processor;
a display having a screen; and
an application operating under the control of the operating environment and operative to perform actions, including:
determining when to show an obstructive user interface element;
showing the obstructive user interface element when determined; and
hiding the obstructive user interface upon the occurrence of an event.

16. The apparatus of claim 15, wherein determining when to show the obstructive user interface element, comprises: predicting a use of the obstructive user interface element by a user.

17. The apparatus of claim 16, wherein predicting the use of the obstructive user interface element, comprises: determining when at least one of the following condition occurs: a hardware notification is received, a start menu is deployed, another application is displayed on the foreground of the small screen, a notification is received, an input panel is raised, a domain changes, and a security level associated with a site changes.

18. The apparatus of claim 15, wherein hiding the obstructive user interface upon the occurrence of the event, comprises: determining when the event that caused the obstructive user interface element has completed.

19. The apparatus of claim 15, wherein hiding the obstructive user interface upon the occurrence of the event, comprises: determining when at least one of the following condition occurs: a menu item is closed, a command finishes processing, a user input received, a user navigates using a directional pad, a notification is dismissed, a period of time elapses with no interaction, and a form submit is completed.

20. The apparatus of claim 16, further comprising setting the device to a full screen mode.
